(19) United States
(12) Patent Application Publication
(10) Pub. No.: US 2007/0251947 A1
(43) Pub. Date: Nov. 1, 2007

(54) Container for Receiving or Holding, Respectively, and Storing Liquids as Well as Viscous Substances, and Method for the Production Thereof

(75) Inventor: Andreas Plengorth, Augsburg (DE)

Correspondence Address: ROTHWELL, FIGG, ERNST & MANBECK, P.C., 1425 K STREET, N.W., SUITE 800, WASHINGTON, DC, 20005, US

(73) Assignee: MT Aerospace AG, Augburg (DE)

(21) Appl. No.: 11/596,175

(22) PCT Filed: May 9, 2005
(86) PCT No.: PCT/EP05/05007

§ 371 Date: Nov. 13, 2006

(30) Foreign Application Priority Data
May 11, 2004 (DE) 102004023286.5

(51) Int. Cl. B60P 3/00

(52) U.S. Cl. 220/562

(57) ABSTRACT

The invention relates to a container for holding and storing liquids as well as viscous substances, particularly drinking water, waste water or fuel. The container has a thin-walled casing (12). The inner side (16) of the coniainer (10) is flat and smooth, and the outerside (18) of the container (10) is provided with integrated reinforcements (20) projecting from the outer side (18). The invention also relates to a method for producing a container (10) of the aforementioned type and to the use thereof.

The invention relates to a container for receiving or holding, respectively, and storing liquids as well as viscous substances, especially drinking water, waste water or fuel, and a method for the production and use of same.

Containers of this kind are generally known. According to the prior art, such containers are often used as metal tanks in the field of aerospace. Containers of this kind are generally of lightweight construction, are largely flat and smooth on the inside to facilitate cleaning and are provided on the outside with stiffeners to withstand the strongly fluctuating differences between the internal and external pressures. To increase the buckling resistance of such containers, a series of measures are proposed according to the prior art that in practice, however, have all proved decidedly disadvantageous because of their structural design.

Thus, for example, the stiffening of a container by using circumferential creases in the wall have the disadvantage in that the surface is then not flat and smooth. Draining the container without leaving a residue is thus impeded. Furthermore, add-on parts and required wall reinforcing in the supporting area to improve the force application cannot be realized. Furthermore, at higher internal pressures plastic deformation of the container is more likely compared with a container with a smooth wall.

Furthermore, stiffeners in the form of surrounding stiffening profiles that are bonded with or to the container are known. This increases the stability of the container under pressure. However, such bonding brings with it numerous problems. For example, expensive pre-treatment of the surfaces of the container and the stiffening profiles is necessary.

Furthermore, a difficulty arises during bonding in that the stiffening profiles are resistant to circumferential bending and have to be curved to fit them against the container, and due to their springiness may have to be matched up on site. Finally, a bonding of this kind has to be decidedly durable and must therefore have a service life of 25 years or more and also meet high mechanical requirements with regard to strength and stiffness, including under unfavorable environmental conditions.

Furthermore stiffening measures have been used in the past consisting of surrounding stiffening profiles joined to the container by spot welding. Admittedly this does away with the problems, already outlined, associated with bonding. Furthermore, the difficulties due to the bending of the stiffening profiles when fitting are less pronounced. However, the stress concentration at the weld points have been shown to be particularly disadvantageous. Furthermore, fine gaps and cracks around the weld points form potential starting points for corrosion. Both lead to a reduction in strength and stiffness and a reduction in the overall service life of the container.

The disadvantages of spot welding can, admittedly, be avoided if the stiffening profiles are welded to the container by a surrounding fillet weld. Because the stiffening profiles are generally thicker than the container, problems likewise occur. On one hand, it is particularly difficult to achieve a complete weld without the thin casing of the container being burnt through in the process, while on the other hand distortion of the thin casing of the container occurs due to local heat application. Furthermore, the producing effort increases, resulting in quite substantial producing costs because two additional welds around the circumference of the container are required to fit each stiffening profile.

Similar disadvantages arise when the container is stiffening by welding in intermediate rings of an increased thickness between the individual sections into which the cylindrical casing is divided. This in turn increases the producing effort and costs quite considerably because the intermediate rings also require two additional welds around the circumference of the container. Furthermore, the fact that the walls of the container are reinforced by intermediate rings that have to be machined on both sides because large step changes in the thickness relative to the casing to which they are welded are not permissible is a great disadvantage.

Finally, a further measure proposed to increase the stability under pressure is the partial or complete winding of the container with a carbon fiber or glass fiber plastic compound. However, with stiffening of this kind the previous problems of a very expensive pre-treatment of the surface of the container and the high demands on the service life of such a bonding also occur. Furthermore, winding is particularly complicated if the container does not have a completely, or almost completely, smooth surface but is instead fitted with a number of connectors, flanges, necks, surfaces for attaching lugs, hand holes, manholes or similar add-on details or add-on parts. Finally, winding of this kind involves high costs.

Furthermore, a complete series of other containers for receiving and storing liquids including viscous substances are known that, however, do not consist completely of metal. DE-OS 1 684 728, for example, describes a cylindrical moveable pressurized container for holding liquids or solids, produced from steel-reinforced concrete. U.S. Pat. No. 4,778,074 discloses a cylindrical container of glass fiber reinforced plastic that is provided with a number of axial ring-shaped stiffening ribs spaced apart from each other. The stiffening ribs that essentially consist of corrugated board and are covered by glass fiber reinforced plastic can be applied over layers of glass fiber reinforced plastic on the outside of the cylindrical container. From U.S. Pat. No. 3,394,841, a cylindrical container of glass fiber reinforced plastic is known that has a number of stiffening ribs in the form of rings on the outside. The stiffening ribs are formed from a low density core material and a preformed layer of glass fiber reinforced plastic surrounding the core material and are secured to the outside of the cylindrical container by a series of layers of glass fiber reinforced plastic.

Finally, U.S. Pat. No. 2,739,047 shows a general method for the chemical milling of metals.

The object of this invention is therefore to provide a container for receiving or holding, respectively, and storing liquids and viscous substances, especially drinking water, waste water or fuel, by means of which the aforementioned disadvantages can be prevented, that is furthermore of particularly simple design, is at the same time compact and stable and of very lightweight construction, has a high strength and stiffness, can withstand high internal and external pressures, enables cleaning and draining without leaving residue, is particularly inexpensive to produce, and to provide a method for its production and use.

This object is achieved with respect to a technical device in a surprisingly simple manner by the features of Claim 1.

Due to the design of the container in accordance with the invention for receiving or holding, respectively, and storing liquids as well as viscous substances, especially drinking water, waste water or fuel, with a thin-walled casing of metal, with the inside of the container being flat and smooth and the outside of the container being provided with integral stiffeners projecting over the outside, a particularly simple construction of the container that is also compact and stable is achieved at relatively low weight. At the same time, the container according to the invention has a high strength and stiffness. In particular, the container according to the invention can withstand high internal and external pressures. Therefore, plastic deformation of the container under specified maximum internal operating pressure is precluded. At the same time, irreversible deformations of the container due to handling or due to the substantial differences in air pressure compared with the initial state, including implosion of the container that occurs in aerospace applications are safely prevented up to a specified external pressure. The container according to the invention is to a certain extend stiffened against buckling. Furthermore, the container according to the invention enables cleaning and draining without leaving a residue. Finally, the container according to the invention is simple and not very labor intensive to produce and is thus decidedly inexpensive.

Further advantageous details of the container according to the invention are described in Claims 1 to 11.

Of quite particular importance for a high strength and stiffness, that at the same time provides high (pressure) stability, are the integral stiffeners according to Claim 2, projecting over the outside and arranged in an area of the container in which the casing forms an easily-deformable hollow body.

In this connection, it is within the scope of the invention to arrange the integral stiffeners that project over the outside in an area of the container in which the thin casing according to Claim 3 forms an elongated, especially circular, oval, elliptical, prismatic, cylindrical or polygonal hollow body, or a hollow body formed from a combination of said shapes.

The measures according to Claim 4 are of particular interest for a simple, compact and stable, i.e. rigid and stiff, construction of the container. Accordingly, the integral stiffeners are arranged in the form of strips on the outside of the casing.

The integral stiffeners are in this case, according to the features of Claim 5, advantageously in the form of parallel strips that run, aligned on the outside of the casing, axially and/or vertically and/or at an angle or obliquely or diagonally, respectively, relative to the longitudinal axis of the container.

As an alternative or an addition to this, the integral stiffeners according to the features of Claims 6 to 8 are of honeycomb, lattice, especially triangular, square, rectangular, polygonal or helical shape and arranged on the outside of the casing.

Furthermore, it is provided by the invention that the integral stiffeners according to Claim 9 are arranged continuously and/or intermittently on the outside of the casing.

It is also within the scope of the invention that the container corresponding to Claim 10 is of lightweight construction and/or is corrosion resistant.

Appropriately, the container in this connection according to Claim 11 is formed of high-grade steel, titanium or an alloy of same. Materials, such as preferably high-grade steel, titanium or an alloy of same, are best suited to meeting the requirements for a minimum weight of the container while at the same time fulfilling the requirements for suitability for drinking water or resistance to waste water.

Furthermore, this object is achieved in a surprisingly simple manner with respect to the technical method by the features of Claim 12.

By means of the method according to the invention for the production of a container for receiving or holding, respectively, and storing liquids as well as viscous substances, especially drinking water, waste water or fuel, with a thin-walled casing of metal, with the casing before or after forming, or the container, being partially covered or masked by an acid-proof varnish or similar and then completely immersed in an acid bath so that the areas of the outside of the container not masked by acid-proof varnish are chemically milled or etched away to form integral projecting stiffeners on the outside, a container can be obtained in a manner that is particularly simple with regard to construction and that has all the advantageous properties previously outlined. In particular, the lightweight container produced in this way with a cylindrical casing and, for example, welded container ends is equipped for use for storing liquids and viscous substances. The inside of the container is thus flat and smooth and enables cleaning and draining to be carried out easily, quickly, and particularly without leaving a residue. The outside of the container is at the same time provided with stiffeners that lend the necessary stability to the casing that is thin-walled for weight reasons. To use the container for aerospace applications and further reduce the weight and producing costs these are what is called integral stiffeners. These can be produced according to the invention in that due to acid masking during the chemical milling or etching away areas are not eroded, i.e. remain, that according to the basic pattern resemble, for example, parallel strips similar to tires, barrel hoops, honeycombs or similar. The container produced in this way can withstand large pressure differences between the inside and outside despite its lightweight construction. The container produced by the method according to the invention is to that extend stiffened against buckling and can withstand high pressure stresses, that not only fluctuate considerably but can also occur both as negative or positive pressures, without any short-term and/or lasting deformation.

Further advantageous details of the method according to the invention are described in Claims 13 to 19.

It is thus advantageously within the scope of the invention that the casing corresponding to the features of Claim 13 is cut from a plate-shaped sheet metal profile, especially from a metal sheet, before the chemical milling or etching.

For a production of the container according to the invention that is both versatile and can yet be individually adapted to suit specific design conditions, the measures provided in Claim 14 are of particular interest. Accordingly, the blank of the casing is formed or worked before or after the chemical milling or etching, into a hollow body of an especially circular, oval, elliptical, prismatic, cylindrical or polygonal cross-section or cross-section formed from a combination of said shapes, preferably by bending, curving or milling and then welding the edges of the joints facing each other.

In a useful manner, the casing or container formed or worked into a hollow body can optionally, according to the measures of Claim 15, be annealed to relieve stress, either before or after the chemical milling or etching.

Furthermore, it is within the scope of the invention to weld connectors, flanges, necks, mounting surfaces for attaching lugs, hand holes or manholes or similar add-on details or add-on parts and domes, dome caps or similar elements, according to Claim 16, to a casing formed or worked into a hollow body. Due to the fact that with the inventive method for producing a container according to the invention the geometrical shape and arrangement of the integral stiffeners on the outside of the container present no difficulties and furthermore offer a versatile and particularly individual choice, no special adaptations or special design preconditions for the aforementioned add-on parts or add-on details are necessary. Thus, for example, it is known in practice that wall reinforcing is necessary in areas where force is introduced, particularly in the mounting area of the container. By suitable masking or covering of such areas, the necessary thickness can, however, be simply obtained without expense.

In a corresponding advantageous manner, areas of the casing, before or after forming, or of the container, that are provided with welds and the adjacent areas according to the features of Claim 17 can also be covered with the acid-proof varnish or similar for the chemical milling or etching in such a way that these areas are not, or at least only to a reduced amount, chemically milled or etched away. In this way, the areas of the welds or the adjacent areas can retain the necessary thickness due to the corresponding masking.

Appropriately, the areas of the casing before or after forming, or of the container according to Claim 18, covered by acid-proof varnish or similar, are cleaned by pickling after the chemical milling or etching. To this extent, the residual acid-proof varnish or similar remaining on the casing and/or container is removed.

According to the invention, it is furthermore provided according to Claim 19 that the container is passivated after the chemical milling or etching, or after the pickling, to prevent corrosion and provide long-term stabilization.

Finally, it is within the scope of the invention to use the container according to the invention for receiving or holding, respectively, and storing liquids as well as viscous substances, particularly drinking water and waste water or fuel, in vehicles, particular land vehicles such as cars, trucks or mobile homes, particularly in watercraft such as submarines or air-cushion vehicles (hovercraft), or particularly in aircraft or aerospace vehicles according to Claim 20.

Further features, advantages and details of the invention are given in the following description of a preferred form of embodiment of the invention, and with the aid of drawings.

The drawings are as follows:

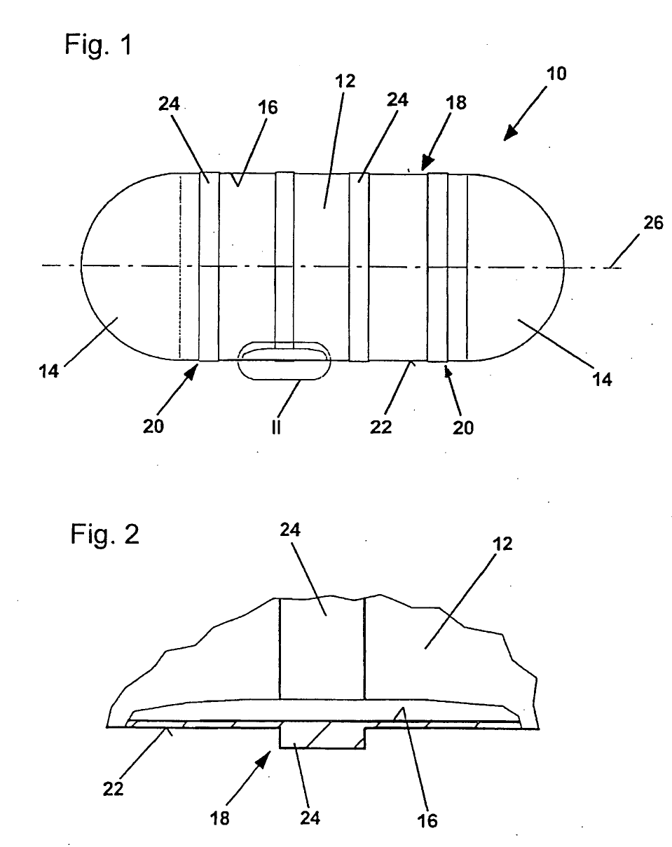

FIG. 1 A schematic plan view of a very simplified form of a form of embodiment of the container according to the invention.

FIG. 2 An enlarged view of a partial cross-section through a casing of the form of embodiment of the container corresponding to Section II in FIG. 1.

In the following description of a form of embodiment of a container 10 in accordance with the invention, with a thin-walled casing 12, for receiving or holding, respectively, and storing liquids as well as viscose substances, especially drinking water, waste water or fuel, components that are the same are provided with identical character references.

The container 10 according to the invention can advantageously be used for receiving or holding, respectively, and storing liquids including viscose substances, especially drinking water, waste water or fuel, in vehicles, especially in land vehicles, watercraft or aircraft. For example the container 10 according to the invention can be used in passenger cars, trucks, mobile homes, in a submarine or air-cushion vehicle (hovercraft). The container according to the invention can be used particularly for aircraft or aerospace vehicles.

The container 10 according to the invention, shown in FIGS. 1 and 2, is for simplicity shown without add-on parts or add-on details, such as connectors, flanges, necks, mounting surfaces for attaching lugs, hand holes, manholes, etc.

The container 10 according to the invention, shown in FIGS. 1 and 2, is formed from a thin-walled casing or shell, respectively, 12 on each end of which a dome 14, a dome-cap or similar element is fitted, for example by welding.

The inside 16 of the container 10 is flat and smooth, as shown in FIGS. 1 and 2. This enables draining and cleaning of the container 10 to be carried out simply and quickly, and particularly without leaving a residue.

As can also be seen in FIGS. 1 and 2, the outside 18 of the container 10 is provided with integral stiffeners 20. The integral stiffeners 20 on the outside 18 of the container 10 project from the outside 18.

In particular the integral stiffeners 20 that extend over the outside 18 of the thin-walled part of the container 10 are arranged in an area of the container 10 in which the thin-walled casing 12 forms an easily deformable hollow body. To this extend, the integral stiffeners, strictly speaking, project on the outside 22 of the casing 12.

The container 10 of the invention, shown in the example of an embodiment in FIGS. 1 and 2, is of circular or elliptical cross-section. Therefore, the integral stiffeners 20 projecting on the outside 18 of the thin-walled part of the container 10 are arranged in an area of the container 10 in which the thin-walled casing 12 forms an elongated, specially for example, cylindrical hollow body.

As can be seen in FIGS. 1 and 2, the integral stiffeners 20 in the illustrated example of an embodiment of the container 10 according to the invention are arranged in the form of strips 24, such as strip-shaped raised areas, tire-type strips or barrel hoops, etc., on the outside 22 of the casing 12. The strips 24 on the outside 22 of the casing 12 in this case run parallel to each other and are axially aligned and/or vertically (not illustrated) and/or at an angle (also not illustrated) relative to the longitudinal axis 26 of the container 10.

Because in the form of embodiment of the container 10 shown in FIGS. 1 and 2 no add-on parts or add-on details are shown, the integral stiffeners 20 are shown arranged continuously on the outside 22 of the casing 12. Without being shown in detail, the integral stiffeners 20 can also be discontinued at specific points, particularly at specially arranged wall reinforcements or in the area of the aforementioned add-on parts or add-on details such as connectors, flanges, etc., that are undetachably fitted to the container 10.

The container 10 is in an advantageous manner of lightweight construction and/or corrosion resistant. Preferably, the container 10, especially the casing 12 of the container 10, is therefore made of metal, such as high-grade steel, titanium or an alloy of same.

The illustrated container 10 according to the invention results in areas with a greater wall thickness that increase the overall stability of the container 10, facilitate welding of additional add-on components or add-on details such as connectors, flanges, etc., and as supporting areas improve the introduction of force into the wall of the container 10. Under internal pressure, the reinforced container of lightweight construction behaves similar to a container with inner and outer sides flat and smooth on both sides, without a premature plastic deformation being able to occur due to buckling. Equally, the container 10 according to the invention is not prematurely or irreversibly deformed under external pressure, for example due to differences in air pressure.

The production of the form of embodiment of the container according to the invention, shown in FIGS. 1 and 2, is explained in more detail in the following:

To produce the container 10 according to the invention, at least one casing is cut from a plate-shaped profile, for example from a metal sheet, that initially has a thickness of the subsequent thin-walled casing plus the thickness of the stiffeners. This blank is then curved or rolled into a required prismatic, preferably cylindrical, shape and the edges of the joints facing each other are welded together. As an option, this prismatic casing 12, with a longitudinal fillet weld, can be annealed to relieve stress. Then, those areas that are not to be removed in an acid bath, i.e. the areas of the subsequent integral stiffeners 20, the inside 16 of the container 10 or of the casing 12 and, as necessary, the weld on the outside 18 of the container 10, complete with the adjacent area, is masked or covered with an acid-proof varnish or similar. The cylindrical casing 12 is then completely immersed or placed in an acid bath.

In doing so, the areas of the outside 22 of the casing 12 that are not masked are chemically milled or etched down to the required thickness of the container 10 and thus the integral stiffeners 20 are, so to speak, simultaneously generated. Then, depending upon the application, add-on parts or add-on details such as connectors are fitted to the casing 12 or flanges are welded to the casing 12 (not illustrated). Domes 14 or dome-caps that have been previously deep drawn are then also welded to both ends of the casing 12. The container 10 is then completely pickled and passivated to protect against corrosion and provide long-term stability.

Alternatively, the welding of the lengthwise weld can take place after the chemical milling or etching. In this case, particular care must be taken to make sure that no excessive changes in wall thicknesses are created in the areas of the joint edges of the blank of the casing 12 by the chemical milling or etching. To this extent, it can be advantageous to protect the adjacent area along the weld seam by applying the acid-proof paint or similar and thus prevent chemical milling or etching in this area.

As an alternative, the stress-relieving annealing and chemical milling or etching does not take place until after the domes 14 or dome-caps and/or all add-on parts or add-on details such as connectors, flanges, etc., have been welded on.

It is advantageous in this case if all the welds, particularly also on the domes 14 or dome-caps and all other add-on parts or add-on details such as connectors, flanges, etc., are heat-treated.

Moreover, the chemical milling or etching also includes the pickling process so that a corresponding separate work stage can be omitted. The slightly increased expense for the masking or covering of the add-on parts or add-on details does not have a serious effect.

The present invention is not restricted to the illustrated form of embodiment of the container 10 and the associated process/ses described for its production. It is thus quite easily conceivable for the integral stiffeners 20 to not be in the form of strips 24 as shown in the example of an embodiment in FIGS. 1 and 2. The integral stiffeners 20 can furthermore also easily be formed and arranged on the outside 22 of the casing 12 as honeycomb, lattice, especially triangular, square, rectangular, polygonal or helical shapes. A combination of such variously shaped stiffeners 20 is also possible in principle.

### Reference Character List

10 Container
12 Thin-walled casing
14 Dome or dome-cap
16 Inside of the container
18 Outside of the container
20 Integral stiffener
22 Outside of casing
24 Strips
26 Longitudinal axis of container.

1. Container for receiving or holding, respectively, and storing liquids as well as viscous substances, especially drinking water, waste water or fuel, with a thin-walled casing (12) of metal, with the inside (16) of the container (10) being flat and smooth and the outside (18) of the container (10) having integral stiffeners (20) projecting on the outside (18).

2. Container according to claim 1, characterized in that the integral stiffeners (20) projecting on the outside (18) are arranged in an area of the container (10) in which the thin-walled casing (12) forms an easily deformable hollow body.

3. Container according to claim 1, characterized in that the integral stiffeners (20) projecting on the outside (18) are arranged in an area of the container (10) in which the thin-walled casing (12) forms an elongated, especially circular, oval, elliptical, prismatic, cylindrical, polygonal or hollow body, or a hollow body formed from a combination of same.

4. Container according to claim 1, characterized in that the integral stiffeners (20) are arranged on the outside (22) of the casing (12) in the form of strips (24).

5. Container according to claim 4, characterized in that the integral stiffeners (20) are arranged in the form of strips (24) parallel to each other that run on the outside (22) of the casing (12) axially aligned with and/or vertically and/or at an angle to the longitudinal axis (26) of the container (10).

6. Container according to claim 1, characterized in that the integral stiffeners (20) are arranged as honeycomb shapes on the outside (22) of the casing (12).

7. Container according to claim 1, characterized in that the integral stiffeners (20) are arranged as lattice, especially triangular, square, rectangle or polygonal shapes on the outside (22) of the casing (12).

8. Container according to claim 1, characterized in that the integral stiffeners (20) are arranged as helical shapes on the outside (22) of the casing (12).

9. Container according to claim 1, characterized in that the integral stiffeners (20) are arranged continuously and/or intermittently on the outside (22) of the casing (12).

10. Container according to claim 1, characterized in that the container (10) is of lightweight construction and/or is corrosion resistant.

11. Container according to claim 1, characterized in that the container (10), especially the casing (12) of the container (10), is made of high-grade steel, titanium or an alloy of same.

12. Method for the production of a container (10) for receiving or holding, respectively, and storing liquids and viscous substances, especially drinking water, waste water or fuel, with a thin-walled casing (12) of metal according to one of the preceding claims, with the casing (12), before or after forming, or the container (10) being partially covered or masked by an acid-proof varnish or similar and then completely immersed in an acid bath so that the areas of the outside (18) of the container (10) not masked by the acid-proof varnish are chemically milled to form integral stiffeners (20) projecting over the outside (18).

13. Method according to claim 12, characterized in that the casing (12) is cut from a plate-shaped profile, especially from a metal sheet, before the chemical milling.

14. Method according to claim 12, characterized in that the blank of the casing (12) is formed or worked, before or after the chemical milling, into a hollow body, especially of a circular, oval, elliptical, prismatic, cylindrical or polygonal cross-section or a cross-section formed from a combination of said shapes, preferably by bending or curving and then welding the edges of the joints facing each other.

15. Method according to claim 12, characterized in that the casing (12) formed or worked into a hollow body or the container (10) can be annealed to relieve stress before or after the chemical milling.

16. Method according to claim 12, characterized in that connectors, flanges, necks, mounting surfaces for attaching lugs, hand holes or manholes or similar add-on parts or domes (14), dome-caps or similar elements can be welded to the casing (12) formed into a hollow body.

17. Method according claim 12, characterized in that areas of the casing (12) before or after forming, or of the container (10) in the vicinity of welds and the adjacent areas are provided with the acid-proof varnish or similar before the chemical milling in such a way that these areas are not chemically milled or milled only to a reduced degree.

18. Method according to claim 12, characterized in that the areas of the casing (12) before or after forming or of the container (10) covered with acid-proof varnish or similar are cleaned by pickling after the chemical milling.

19. Method according to claim 12, characterized in that the container (10) is passivated after the chemical milling or after the pickling, to prevent corrosion and provide long-term stabilization.

20. Use of a container according to claim 1, for receiving or holding, respectively, and storing liquids and viscous substances, especially drinking water, waste water or fuel, in vehicles, especially land vehicles, preferably in passenger cars, trucks or mobile homes, especially in watercraft, preferably in a submarine or air-cushioned vehicle (hovercraft), or particularly in aircraft or aerospace vehicles.
